(19) United States
(12) Patent Application Publication
(10) Pub. No.: US 2013/0278413 A1
(43) Pub. Date: Oct. 24, 2013

(54) Electronic Leash System for Personal Articles

(71) Applicants: Vikram John Kamath, Cupertino, CA (US); Karan Aujla, Greenbrae, CA (US)

(72) Inventors: Vikram John Kamath, Cupertino, CA (US); Karan Aujla, Greenbrae, CA (US)

(21) Appl. No.: 13/864,874

(22) Filed: Apr. 17, 2013

Related U.S. Application Data
(60) Provisional application No. 61/687,294, filed on Apr. 23, 2012.

(51) Int. Cl. G08B 21/18

(52) U.S. Cl. CPC G08B 21/18
USPC 340/539.11

(57) ABSTRACT

The present invention is directed to an electronic leash system to prevent the misplacement of a personal article and/or to facilitate the location of a personal article. An embodiment of this novel invention utilizes a wireless connection between a first element worn on or attached to the person or clothing of a user, and a second element optionally housed within or fashioned in the form of a protective case for a personal article. In an embodiment of the invention, when the distance between the first element and the second element exceeds some specified critical distance, an alarm may be raised to alert the user. The critical distance may in some embodiments be specified through the use of a computer program, said program being ideally contained on or accessible via the personal article.

This application claims the benefit of U.S. Provisional Patent Application Ser. No. 61/687,294 filed Apr. 23, 2012.

### BACKGROUND OF THE INVENTION

1. Field of the Invention

The current invention relates to the field of electronic leashes, in general, and more specifically to an apparatus to prevent the misplacement of personal articles and to facilitate their facile location upon misplacement. This is accomplished via the use of an “electronic leash”—a system by which an alarm may be raised when a preset critical distance between two or more objects is exceeded. A basic feature of an electronic leash is the presence of a transmitter of wireless signals in one or more object(s), a receiver of wireless signals in on or more object(s), and an alarm that may be activated when the distance between the objects being monitored exceeds a specified critical distance.

2. Description of the Related Art

The current invention overcomes several key limitations in the prior art, and addresses long felt needs in the industry. The related art generally comprises systems and apparatuses that wirelessly connect a personal article to another object for purposes of measuring distance between the two or facilitating location of the personal article.

With the proliferation of wireless communication devices, personal electronic devices and other such articles commonly carried on or about a user's person, the need has arisen to prevent misplacement of these personal articles, and further to facilitate their recovery upon misplacement. These personal articles may contain or have access to a variety of information, the loss of which may be detrimental to one's personal or business interests.

With the foregoing in mind, several attempts have been made to address this problem, which varying degrees of success. However, all prior attempts suffer from key limitations, which the current invention seeks to overcome. Information relevant to attempts to address these problems can be found in U.S. Pat. No. 7,535,357 (Enitan); U.S. Pat. No. 7,719,418 (Grossman); 7,L48,90L (Crabtree); U.S. Pat. No. 6,744,787 (Melbourne); and U.S. Pat. No. 6,355,202 (Rosenthal J; along with U.S. patent application Ser. Nos. 72/726,562 (Rajann) and 10/396,910 (Walter). The listing of the aforementioned patents and patent applications is not an indication of their status as prior art to the invention claimed and disclosed herein.

Each one of the aforementioned references embody one or more of the following negative characteristics or suffer from one or more of the following disadvantages: personal article locator systems that only permit a monitored personal article to be found, rather than first preventing misplacement from occurring; systems wherein the transmitter and receiver that comprise the electronic leash are internal to or not easily detachable from the personal article; systems wherein one element of the electronic leash is not of a form of object that may be worn on or attached to the person or clothing of a user; systems that rely for power on the power cell of the personal article thereby limiting their utility to instances when the personal article is itself powered; systems consisting of a defined hierarchy such as one parent and several children devices; systems with no easy method for setting the distance which when exceeded causes an alarm to be raised; and/or systems and apparatuses that are cumbersome or expensive to use or would be deemed unfashionable to wear.

### BRIEF SUMMARY OF THE INVENTION

The present invention is directed to an apparatus that satisfies long felt needs in the industry and shortcomings in the prior art, including those described above. An embodiment of the present invention comprises an electronic leash system that helps prevent the misplacement of personal articles, and also helps in locating personal articles.

An embodiment of the presently disclosed electronic leash system apparatus is comprised of a first element to be worn on or located about the person or clothing of the user; and a second element that may comprise a protective case for a personal article or be contained within a protective case for a personal article. The aforementioned electronic leash system may further comprise an alarm that may be capable of auditory, tactile and/or visual perception. As such the alarm may comprise a sound source for raising an audible alarm, a vibratory device or other means of raising a tactile alarm, and/or lights which may be activated or made to flash in order to raise a visual alarm. The invention may furthermore comprise a computer program, through the use of which a critical distance between the first element and second element may be specified which when exceeded triggers the electronic leash system's alarm, thereby alerting the user.

Unlike systems and apparatuses known or described in the prior art the present invention seeks to proactively prevent misplacement through an electronic leash system, triggering an alarm when a specified distance between the first and second elements is exceeded. A major limitation of many prior art solutions to the problem of personal article misplacement was that those solutions possessed utility only after the personal article was already misplaced. The present invention, on the other hand, seeks to first prevent misplacement from ever happening by alerting the user when the personal article is moved further than a specified distance away from the user's wearable article (the first element). By actively monitoring the personal article's position relative to the first element (and therefore relative to a user's person), the present invention displays greater utility. Rather than a system capable of being triggered once the monitored article has already been misplaced, the current invention actively prevents misplacement by keeping the first and second elements on the ends of a virtual electronic leash whose length may be specified.

Unlike other systems, which may consist of hierarchies of monitored objects, the current invention contemplates a simple system wherein the first element and second element comprise the ends of an electronic leash, and either or both of them may contain the components of the alarm and the wireless transmitter and receiver.

A further aspect of the present invention is that both the first element and the second element contain power sources. Each power source may be a battery and/or a solar cell or other means of storing and supplying power known in the industry, and may be replaceable or rechargeable via the solar cell or through connection to an external power source through micro-USB or a other connective technology known in the art. This aspect is an improvement over prior art systems, because the second element, when affixed to the personal article, need not rely on the personal article's power source during operation of the electronic leash. This overcomes the limitation in some prior art systems that required the personal article to be powered or in operation in order to be located via an electronic leash or similar locator systems.

Moreover, an embodiment of the current invention contemplates a relatively simple and inexpensive system, wherein the first element may be easily coupled to or decoupled from the person or clothing of a user, by being worn as an article of fashion or installed within some article of fashion or utility, designed to be worn by a user. This is an improvement over prior art systems which may have featured a keychain or similar article as a first element, and a Bluetooth connection to a second element, because in the current invention the first element is more likely to be present on the person of a user and not itself misplaced.

The second element of the present invention may take the form of or be housed within a protective case for a personal article. The use of such protective cases has rapidly increased with the increased proliferation of personal electronic devices and wireless communication devices, and such cases may be considered fashionable, and are desirable for both their utilitarian aspects and their visual appeal. Such a protective case may be relatively easily affixed to or removed from a personal article, such that the electronic leash system may be easily implemented or stopped through such physical manipulation.

An embodiment of the present invention comprises the further novel aspect of a computer program, which may take the form of an “app” or application, or other computer program possibly contained within or accessible via the personal article. In the case where the personal article comprises a cellular telephone or similar wireless communications device or personal electronic device, the computer program or “app” may be present within or accessible via the personal article. Using the computer program a critical distance may be specified, such that when the first element and the second element are physically separated by a distance in excess of the specified critical distance, the electronic leash system alarm will be triggered.

Moreover, for the fashion conscious, prior art systems often encompassed embodiments that would be deemed unfashionable by many potential users, resulting in limited commercial viability. However, the current invention encompasses embodiments wherein the first element is adaptable to be housed in or take the form of objects that may be considered fashionable, such as (but not limited to) bracelets, anklets, pendants, brooches, rings, timepieces, etc. and the second element may be a protective case for a personal article that may itself be customizable and fashionable.

### REFERENCES TO AND BRIEF DESCRIPTION OF THE SEVERAL VIEWS OF THE DRAWING

These and other features, aspects, and advantages of the present invention will become better understood with regard to the following description, appended claims, and accompanying drawings wherein:

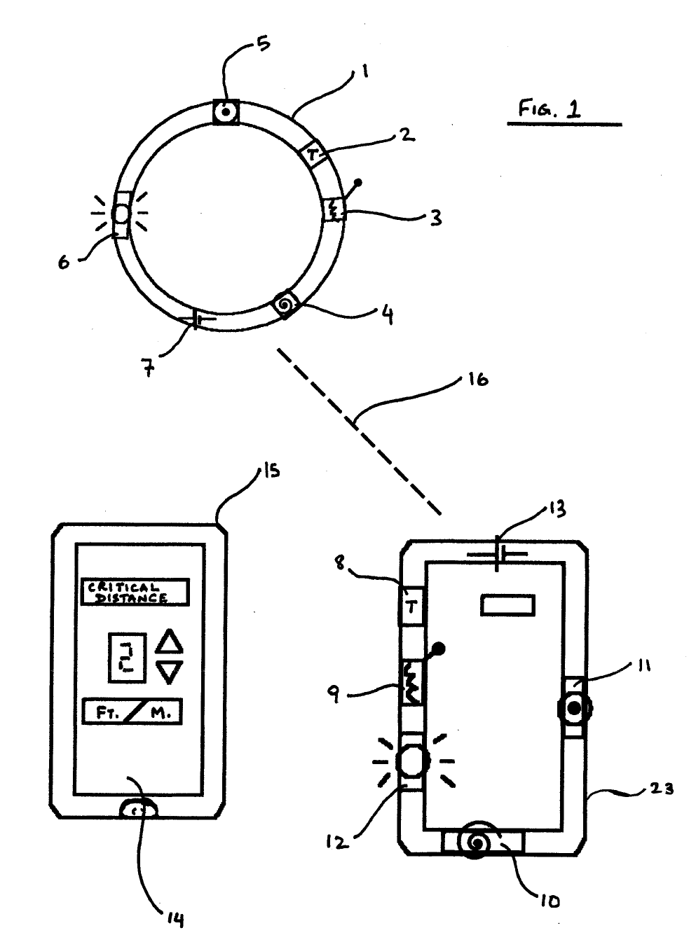

FIG. 1 shows an embodiment of the present invention wherein the first element comprises an article of fashion similar to a bracelet or anklet, the second element comprises an object similar to a protective case for a wireless communication device such as a smartphone, and the computer program comprises an app or application housed on or accessible via the wireless communication device;

FIG. 2 shows another embodiment of a part of the invention wherein the first element has been fashioned in the shape of a pendant to be worn on a necklace; and

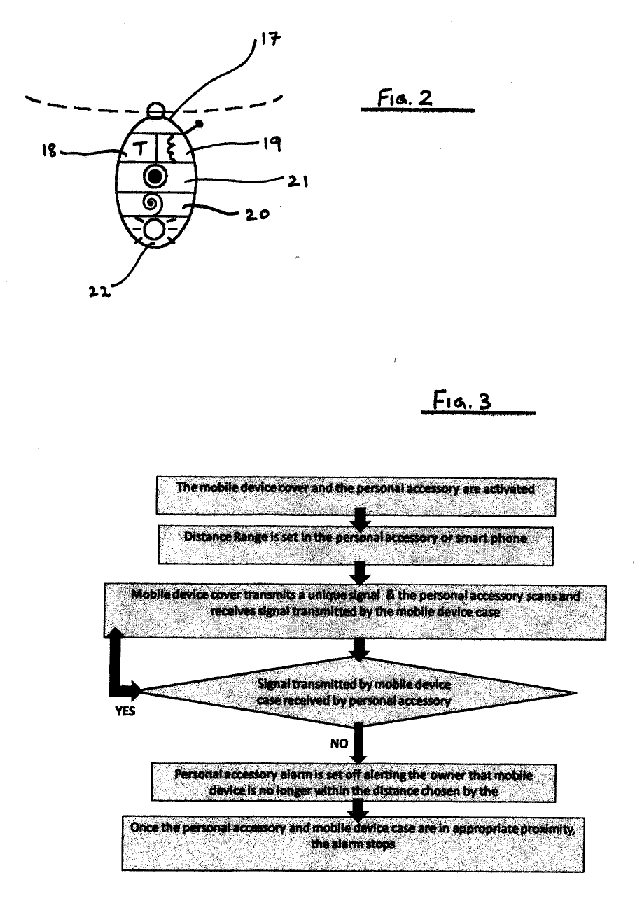

FIG. 3 shows a possible flowchart for workflow of one possible embodiment of the invention.

### DESCRIPTION

In the present invention, a personal article may be any object that a person may want to carry on or about their person, and more specifically may include wireless communication devices, personal electronic devices, and the like. The critical distance is the distance which when exceeded would cause the electronic leash system alarm to be triggered. The electronic leash system alarm may be any of or a combination of visual, auditory and/or tactile signals generated from the first element and/or second element 23.

As shown in FIG. 1, the electronic leash for personal articles comprises a first element 1, and a second element 23. The first element 1 comprises an object capable of being worn on or around the person of the user or affixed to the person or clothing of a user. The first element 1 further comprises a transmitter 2 and/or receiver 3, along with an optional vibrating member 4, an optional sound emitting member 5, and/or an optional light emitting member 6. The first element 1 is further comprised of a power source 13.

As shown in FIG. 1, the second element 23 comprises an object capable of being housed within or fashioned in the form of a protective case for a personal article. The second element 23 is comprised of a transmitter 8 and/or receiver 9. The second element 23 is further comprised of an optional vibrating member 10, an optional sound emitting member 11, and/or an optional light emitting member 12. The second element 23 is also comprised of a power source 13.

The present invention contemplates an electronic leash system, as exemplified in FIG. 1, wherein an alarm may be triggered when the distance between the first element 1 and the second element 23 exceeds some critical distance. This critical distance may be preset, may be set during configuration of the system at the factory or retailer, or may be set through a computer program 14. Said computer program 14 is ideally contained in or accessible via the personal article 15 whose protection is sought and whose misplacement the electronic leash system seeks to prevent or remedy.

The alarm for the electronic leash system, as exemplified in FIG. 1, may be auditory, tactile and/or visual in nature. As such, the alarm may be a combination of one or more of the optional vibrating member 4, the optional sound emitting member 5, the optional light emitting member 6, the optional vibrating member 10, the optional sound emitting member 11, and/or the optional light emitting member 12. When triggered, the purpose of the alarm is to alert the user to the critical distance having been exceeded. As such, any of the combination of sound emitting members, light emitting members, and/or vibrating members on either or both the first element 1 and/or the second element 23 could accomplish said purpose.

The electronic leash system embodied in FIG. 1 may further comprise a computer program 14, ideally contained within or accessible via the personal article 15. The computer program 14, which may take on the form of a smartphone application or “app” or other such program, is primarily tasked with setting the critical distance. The critical distance may be preset at the factory or retailer, and may be subsequently changed by means of the software program 14. The critical distance may also optionally be set via electronic circuitry present in or around the first element 1.

Depending on the desired production cost and anticipated pricing of the electronic leash system as embodied in FIG. 1, any of the following combinations may be implemented for the electronic leash: the first element 1 may comprise a transmitter 2 and the second element 23 may comprise a receiver 9; the first element 1 may comprise a receiver 3 and the second element 23 may comprise a transmitter 8; the first element 1 may comprise both a transmitter 2 and a receiver 3 and the second element 23 may comprise either a transmitter 8 or a receiver 9; the first element 1 may comprise either a transmitter 2 or a receiver 3 and the second element 23 may comprise both a transmitter 8 and a receiver 9.

The wireless connection between the transmitter 2 and/or receiver 3 of the first element 1 and the transmitter 8 and/or receiver 9 of the second element 23 may be effectuated by any of the following means and or their functional equivalents known in the industry, inter alia, Infrared technology (405 Thz-300 Ghz) for low-cost and line-of-sight applications; T2 Radio frequency band (300 Mhz-3 Hz) including RFID technology for longer range wireless connections that are capable of passing through solids and walls; GPS (global positioning system) technology for advanced tracking functionality, or a combination of these or other technologies known in the industry, or their approximate equivalents now known or later developed.

Of these the inventors contemplate the best mode of practicing the invention to encompass use of the radio frequency, with the ideal technology or combination of technologies being capable of working over 10 or 15 meters, but covering longer distances depending on the desired end use. A few of the radio frequency bands that could be used for the current invention include: 433 Mhz ISM band for unregulated customer-specific communications solutions; 868 Mhz band for regulated bandwidth with less noise interference and better transmission quality;

etc. Other alternated radio frequency bands may be used, depending on the contemplated range of critical distance, pricing and security requirements of the end product.

The power source 7 of element 1 and the power source 13 of element 23 perform the function of powering the electrical circuitry of the respective elements. These power sources further ensure that the electronic leash function may be carried out even when the personal article is not powered, thereby enhancing the loss prevention and remedy functions. The two power sources could be a battery or a solar cell, or a battery and solar cell combination. The battery may be of a single-use variety or re-chargeable through use of the solar cell or via a mini-USB or substantially functionally similar port connectable to the personal article or other external power supply or power source. Thus, critically, the second element 23 will have its own power source and will not depend on the personal article 14 for its ongoing power requirements during use of the electronic leash system.

In light of the foregoing disclosure, we hereby claim:

1. An electronic leash system to prevent misplacement of a personal article and facilitate location of a personal article, comprising:
a first element capable of being worn on or affixed to the person or clothes of a user;
a second element, capable of being housed within or fashioned in the form of one or more protective case(s) for personal articles;
an optional electronic leash system alarm being capable of any or more of auditory, tactile and/or visual perception; and
an optional computer program.

2. An electronic leash system to prevent misplacement of a personal article and facilitate location of a personal article, comprising:
a first element, said first element comprising a transmitter and/or receiver, a power source, an optional sound emitting member, an optional vibrating member, and an optional light emitting member, said first element being capable of being worn on or affixed to the person or clothes of a user;
a second element, said second element comprising a transmitter and/or receiver, a power source, an optional sound emitting member, an optional vibrating member, and an optional light emitting member, said second element capable of being housed within or fashioned in the form of one or more protective case(s) for personal articles;
an electronic leash system alarm, said alarm comprising a alerting signal capable of being triggered when the first element and second element exceed a certain distance from one another, said alarm being housed in either the first element or the second element or both, said alarm being capable of auditory, tactile and/or visual perception; and
a computer program, said computer program being programmable by the user to specify a critical distance which, when exceeded, would cause the electronic leash system alarm to be triggered, said computer program being programmable or manipulatable via the personal article associated with the second element.

3. The system of claim 2, wherein the personal article associated with the second element is a portable electronic device, a wireless communication device, or any similar device.

4. The system of claim 2, wherein the electronic leash system alarm comprises a sound emitted by the first element, or the second element, or both the first and second elements, when the distance between the first element and second elements exceeds the critical distance.

5. The system of claim 2, wherein the electronic leash system alarm comprises an activation of the vibrating member of the first element, or the second element, or both the first and second elements, when the distance between the first element and second elements exceeds the critical distance.

6. The system of claim 2, wherein the electronic leash system alarm comprises an activation of the light emitting member of the first element, or the second element, or both, when the distance between the first element and second element exceeds the critical distance.

7. The system of claim 2, wherein the transmitter and/or receiver of the first and/or second element comprises a means for wireless transmission over distances.

8. The system of claim 2, wherein the computer program is an application contained within or accessed via the personal article associated with the second element.

9. The system of claim 2, wherein the computer program comprises a means of selecting the distance which when exceeded would activate the electronic leash system alarm.

10. The system of claim 2, wherein the computer program comprises a means of selecting the nature of the electronic leash system alarm.

11. The system of claim 2, wherein the first element is an article of clothing such as a bracelet, anklet, necklace, or similar article, with said article being preferably of a type considered fashionable or desirable.

12. The system of claim 2, wherein the power source of the first element comprises a battery and/or a solar cell, with said battery being replaceable or rechargeable via the solar cell or connection to a power source.

13. The system of claim 2, wherein the power source of the second element comprises a battery and,/or a solar cell, with said battery being replaceable or rechargeable via the solar cell or connection to a power source.

14. A method for preventing the misplacement of personal articles and/or facilitating the relatively facile recovery of personal articles comprising the use of the system described in claim 2 for the active monitoring of the distance between the first element and the second element and the alerting of a user when such distance exceeds the critical distance.
